(19) United States
(12) Patent Application Publication
(10) Pub. No.: US 2025/0290878 A1
(43) Pub. Date: Sep. 18, 2025

(54) DYNAMIC INSPECTION OF HIGHLY DEFECTIVE WAFERS

(71) Applicant: KLA Corporation, Milpitas, CA (US)

(72) Inventors: Martin Plihal, San Francisco, CA (US); Prasanti Uppaluri, Saratoga, CA (US)

(21) Appl. No.: 19/006,627

(22) Filed: Dec. 31, 2024

Related U.S. Application Data
(60) Provisional application No. 63/564,994, filed on Mar. 14, 2024.

(51) Int. Cl. G01N 23/2251; G01N 21/88; G01N 21/95; G01N 23/203

(52) U.S. Cl. CPC G01N 23/2251; G01N 21/8851; G01N 21/9501; G01N 23/203; G01N 2223/6116

(57) ABSTRACT

A system for dynamic inspection of a wafer is disclosed. The system includes a controller including one or more processors configured to execute a set of program instructions. The program instructions are configured to cause the processors to receive an unsupervised optical scan of the wafer; generate contextual outliers for the wafer, wherein the contextual outliers are unique for the wafer; partition inspection results from the unsupervised optical scan of the wafer into a plurality of strata based on a strength of signal for each event; determine a fixed number of the events to be partitioned into each of the plurality of strata; review the unsupervised optical scan with an electron beam scan of the wafer; determine an estimated number of defects of interest based on results of the electron beam scan of the wafer; determine one or more defect type classifications; and generate wafer signatures.

### CROSS-REFERENCE TO RELATED APPLICATION

The present application claims the benefit under 35 U.S.C. § 119(e) of U.S. Provisional Application Ser. No. 63/564,994, filed Mar. 14, 2024, entitled DYNAMIC INSPECTIONS FOR HIGHLY DEFECTIVE WAFERS, which is incorporated herein by reference in the entirety.

### TECHNICAL FIELD

This disclosure relates broadly to wafer inspection, and, more particularly, to defect detection of highly defective wafers.

### BACKGROUND

Memory fabrications, especially during the research and development (R&D) phase, create three main challenges with respect to the standard methods of optical inspection (e.g., inspection using broadband plasma (BBP)) for process monitoring. The first challenge is with highly defective wafers, where defectivity on the wafer can reach tens of millions or hundreds of millions of defects on a wafer. The number of defects in such wafers cannot be accommodated by any inspection that customers could use and thus it is difficult to estimate the true defect count on the wafer. Fabrication facilities need BBP inspection to track defect count and wafer signatures to improve the various fabrication processes of the facility. This tracking is impossible if BBP inspection results cannot accommodate high defect counts. Second, even small changes in the fabrication process can lead to huge variations in defect counts and even larger variability in nuisance and noise sources, which compounds the problem of inspection blowups. This causes inspection to become unstable, leading to frequent inspection failure. Finally, the characteristics of defects of interest (DOIs) and nuisance events are increasingly unstable in relation to the classification boundaries of detection and nuisance filtering algorithm. This instability is inherent in the images provided by the broadband plasma tool, and makes static inspection run with severely sub-optimal sensitivity on each wafer.

These three problems make broadband plasma inspection extremely difficult to control, which, in turn, reduces the effectiveness of broadband plasma tools to guide process monitoring. These problems are also becoming more severe with each new technology node as optical inspection processes are required to detect smaller and weaker defects. Since wafer noise is even more difficult for fabrication to control than defectivity, it is inevitable that this problem will grow.

Currently, the only method to inspect wafers today is by tuning optical (e.g., BBP) inspection on one (or multiple) wafer(s) using defect of interest (DOI) and nuisance populations discovered on the wafer with scanning electron microscope (SEM) review and, then, running the tuned static optical inspection on subsequent wafers.

Therefore, it is desirable to provide a system and method that address the above deficiencies.

### SUMMARY

A system for dynamic inspection of a wafer is disclosed, in accordance with one or more embodiments of the present disclosure. In embodiments, the system includes a controller including one or more processors configured to execute a set of program instructions stored in memory. In embodiments, the program instructions are configured to cause the processors to receive an unsupervised optical scan of the wafer from an optical inspection tool. In embodiments, the program instructions are configured to cause the processors to generate contextual outliers for the wafer, wherein the contextual outliers are unique for the wafer. In embodiments, the program instructions are configured to cause the processors to partition inspection results from the unsupervised optical scan of the wafer into a plurality of strata based on a strength of signal for each event detected by the unsupervised optical scan. In embodiments, the program instructions are configured to cause the processors to determine a fixed number of the events to be partitioned into each of the plurality of strata. In embodiments, the program instructions are configured to cause the processors to review the unsupervised optical scan with an electron beam scan of the wafer received from a review tool. In embodiments, the program instructions are configured to cause the processors to determine an estimated number of defects of interest based on results of the electron beam scan of the wafer. In embodiments, the program instructions are configured to cause the processors to determine one or more defect type classifications based on the electron beam scan of the wafer. In embodiments, the program instructions are configured to cause the processors to generate wafer signatures.

A system for dynamic inspection of a wafer is disclosed, in accordance with one or more embodiments of the present disclosure. In embodiments, the system includes an optical inspection tool. In embodiments, the system includes a review tool. In embodiments, the system includes a controller including one or more processors configured to execute a set of program instructions stored in memory. In embodiments, the program instructions are configured to cause the processors to receive an unsupervised optical scan of the wafer from an optical inspection tool. In embodiments, the program instructions are configured to cause the processors to generate contextual outliers for the wafer, wherein the contextual outliers are unique for the wafer. In embodiments, the program instructions are configured to cause the processors to partition inspection results from the unsupervised optical scan of the wafer into a plurality of strata based on a strength of signal for each event detected by the unsupervised optical scan. In embodiments, the program instructions are configured to cause the processors to determine a fixed number of the events to be partitioned into each of the plurality of strata. In embodiments, the program instructions are configured to cause the processors to review the unsupervised optical scan with an electron beam scan of the wafer received from a review tool. In embodiments, the program instructions are configured to cause the processors to determine an estimated number of defects of interest based on results of the electron beam scan of the wafer. In embodiments, the program instructions are configured to cause the processors to determine one or more defect type classifications based on the electron beam scan of the wafer. In embodiments, the program instructions are configured to cause the processors to generate wafer signatures.

A method for dynamic inspection of a wafer is disclosed, in accordance with one or more embodiments of the present disclosure. In embodiments, the method includes receiving an unsupervised optical scan of the wafer from an optical inspection tool. In embodiments, the method includes generating contextual outliers for the wafer, wherein the contextual outliers are unique for the wafer. In embodiments, the method includes partitioning inspection results from the unsupervised optical scan of the wafer into a plurality of strata based on a strength of signal for each event detected by the unsupervised optical scan. In embodiments, the method includes determining a fixed number of the events to be partitioned into each of the plurality of strata. In embodiments, the method includes reviewing the unsupervised optical scan with an electron beam scan of the wafer received from a review tool. In embodiments, the method includes determining an estimated number of defects of interest based on results of the electron beam scan of the wafer. In embodiments, the method includes determining one or more defect type classifications based on the electron beam scan of the wafer. In embodiments, the method includes generating wafer signatures.

### BRIEF DESCRIPTION OF THE DRAWINGS

The numerous advantages of the disclosure may be better understood by those skilled in the art by reference to the accompanying figures.

FIG. 1A illustrates a block diagram of a system for dynamic inspection of a wafer, in accordance with one or more embodiments of the present disclosure.

FIG. 1B illustrates a simplified schematic of a system for dynamic inspection of a wafer, in accordance with one or more embodiments of the present disclosure.

FIG. 1C illustrates a simplified schematic of a system for dynamic inspection of a wafer, in accordance with one or more embodiments of the present disclosure.

FIG. 2 illustrates a flow diagram depicting a method for dynamic inspection of a wafer, in accordance with one or more embodiments of the present disclosure.

FIG. 3A illustrates a conceptual view of a process of determining contextual outliers, in accordance with one or more embodiments of the present disclosure.

FIG. 3B illustrates a graph of events from an optical scan based on signal strength, in accordance with one or more embodiments of the present disclosure.

FIG. 4 illustrates a conceptual view of a process of stratifying the events into different strata, in accordance with one or more embodiments of the present disclosure.

FIG. 5A illustrates an inspection flow, in accordance with one or more embodiments of the present disclosure.

FIG. 5B illustrates an inspection flow, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to dynamic wafer inspection that requires no up-front setup. The dynamic inspection of the present disclosure may implement unsupervised generation of scans with contextually segmented signal outliers whose count is fixed via stratification even when defectivity, wafer noise, and nuisance vary from wafer to wafer. This may include contextual outlier generation, stratification of inspection results, and two different inspection flows that support different fabrication operational logistics.

The dynamic inspection may begin with an unsupervised optical scan and be followed by an electron beam scan. The electron beam scan may be made more efficient through stratification of results from the unsupervised optical scan. The stratification may place detected events into different strata based upon a signal strength of the event.

Dynamic inspection may present a new way to inspect wafers when compared to traditional inspection. In traditional inspection techniques, the inspection may be static, which uses the same inspection technique for each wafer. However, in dynamic inspection, the inspection of each wafer may be different from any other wafer inspected.

Such a dynamic inspection technique may provide several advantages over present methods of defect detection. For example, inspection will not blow up, irrespective of the number of defects on the wafer, any excursions in bad dies, or wafer noise characteristics. By way of another example, defect count estimates will be possible for orders of magnitude larger defect count variability than is possible today, where the estimate errors can be controlled by scanning electron microscope review budget. By way of another example, each inspection may be tuned to a selected level, and the tuning may be fully automated. Additionally, despite changing inspection between wafers, the technique will produce meaningful and actionable results, because it will be tuned to the same operating point for wafer signatures and will produce more accurate defect of interest (DOI) count estimates than static inspection.

Dynamic inspection has the potential of making broadband plasma (BBP) inspection in research and development (R&D) memory fabrications (and possibly beyond) much more valuable with inspection results that are actionable. Dynamic inspection accomplishes this by eliminating inspection blow-ups, eliminating tedious and frequent inspection retuning, and enabling accurate and unbiased defectivity estimates across much larger variations in processes.

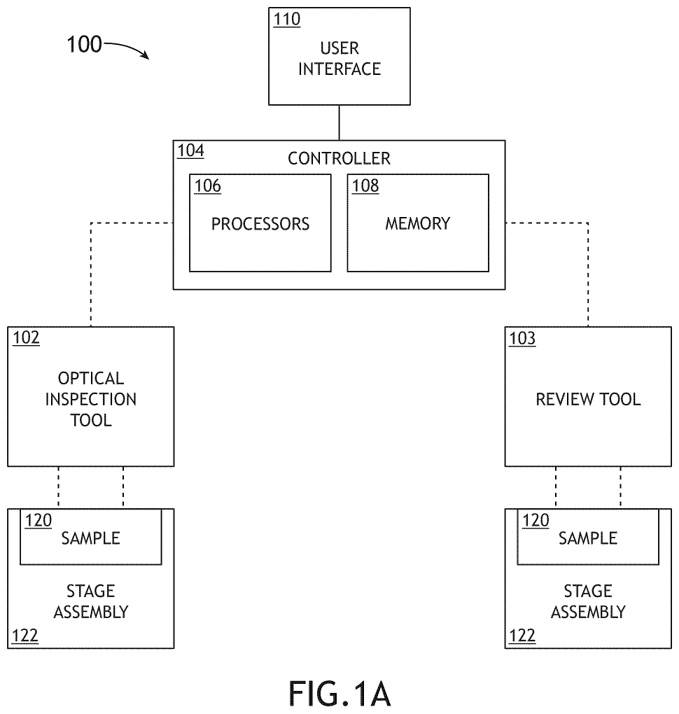

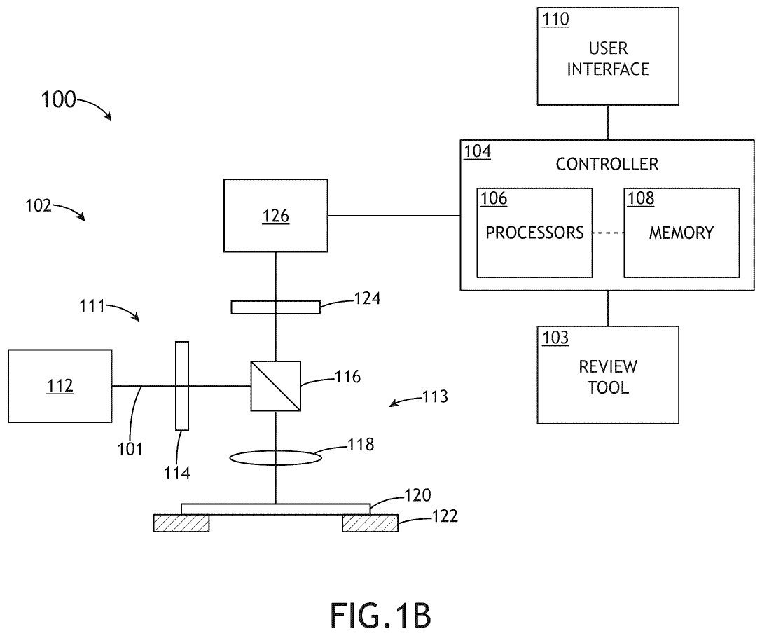

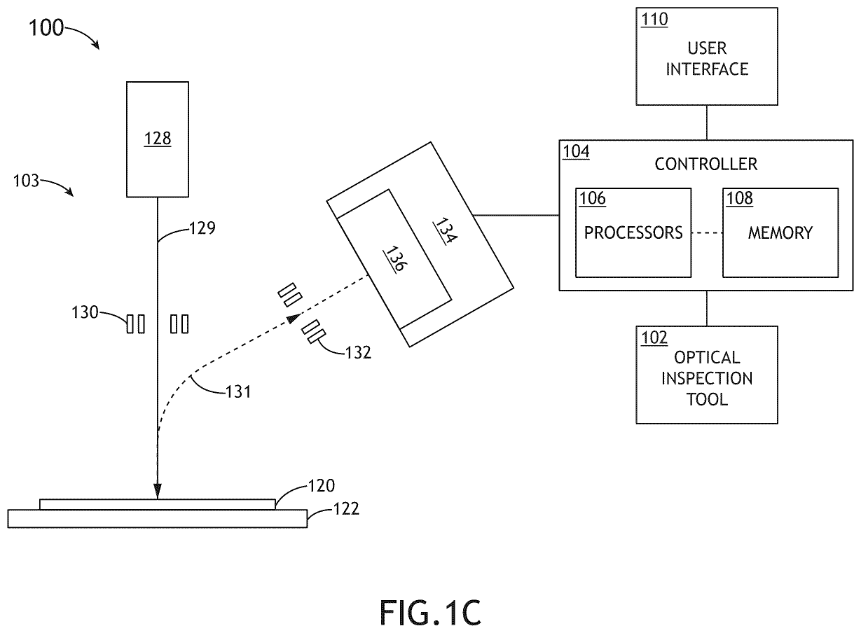

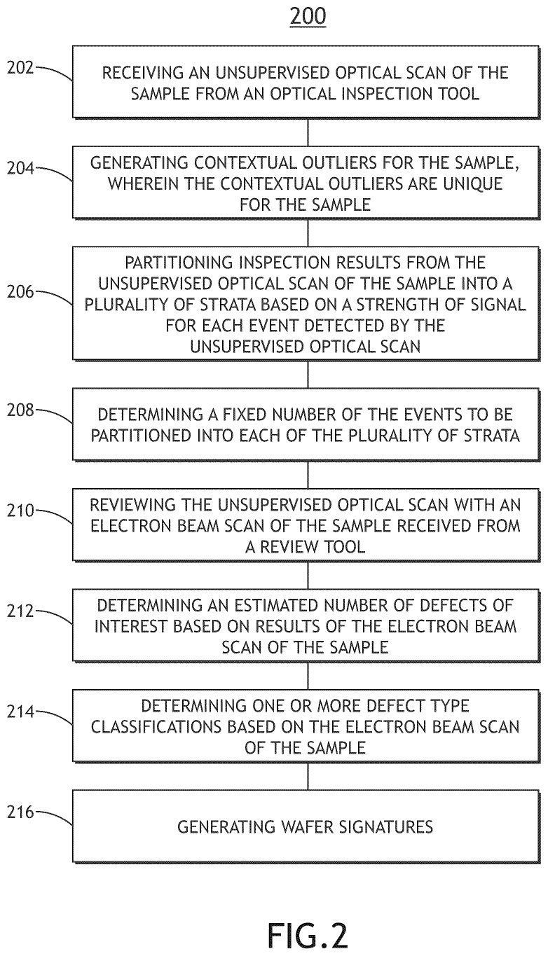

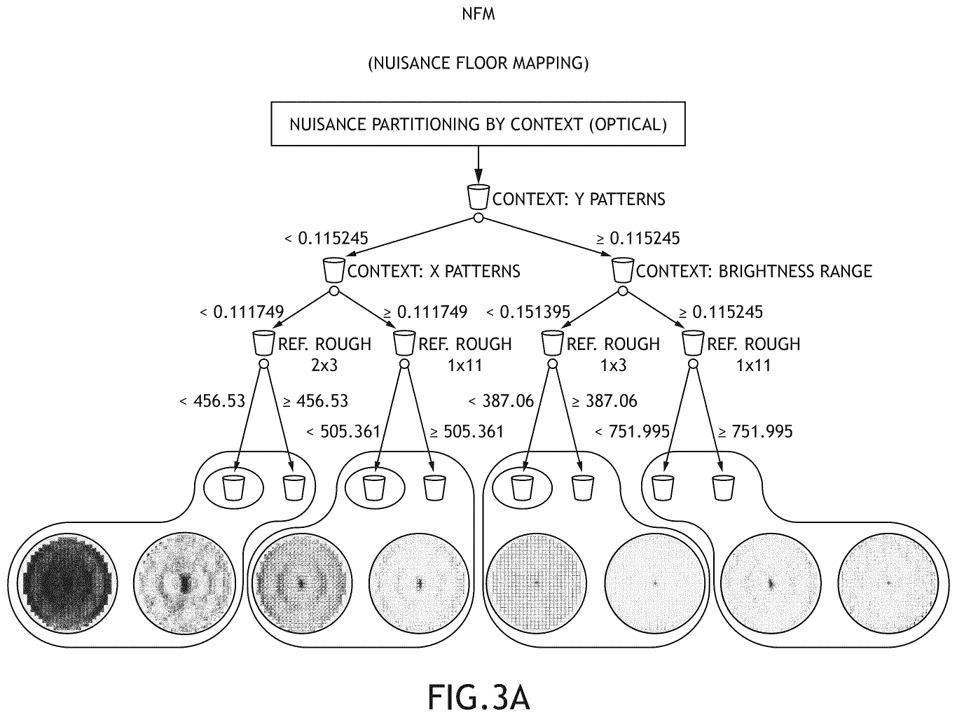

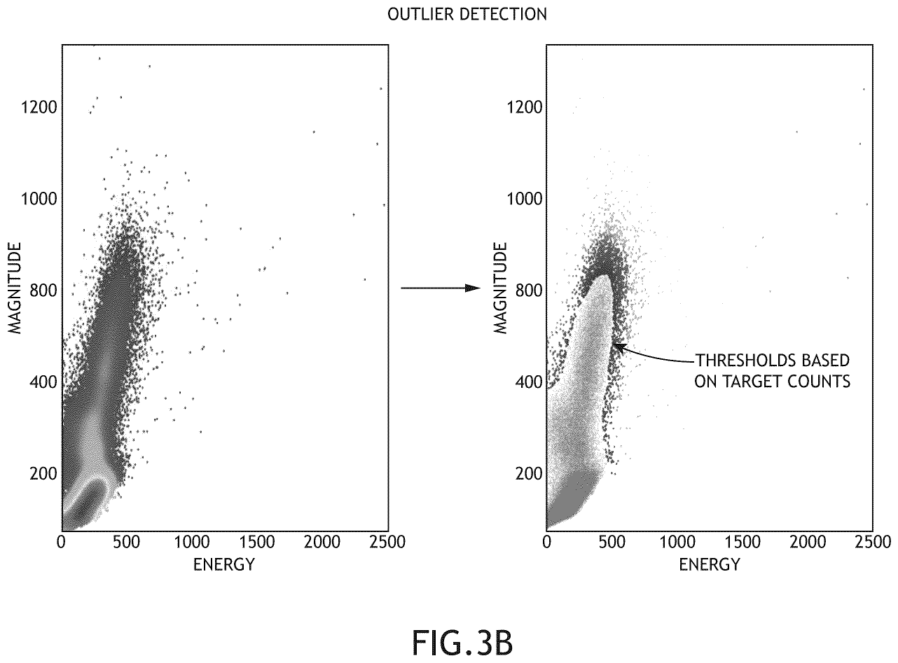

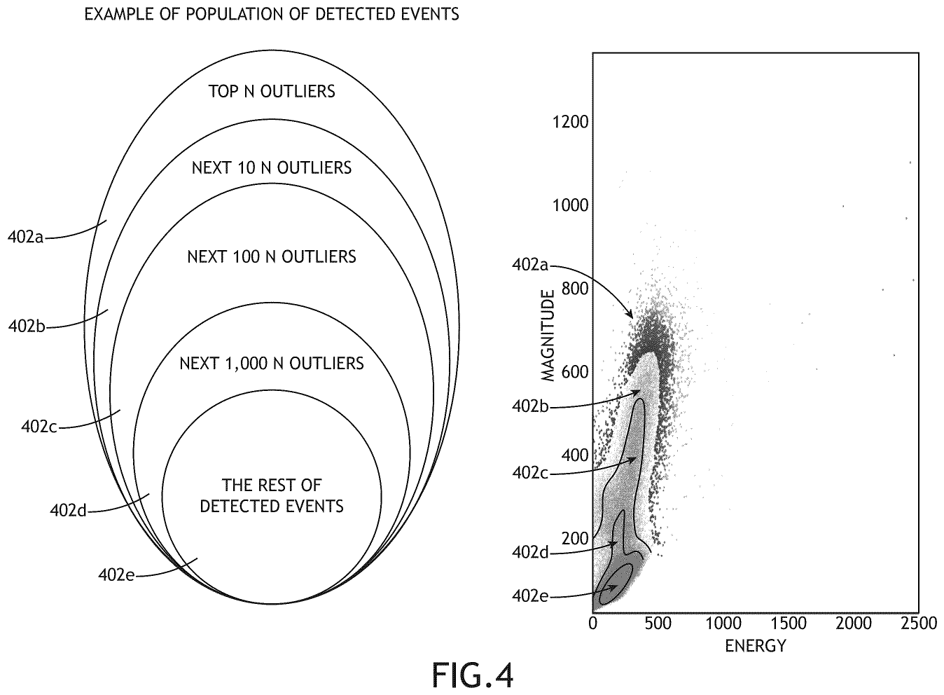

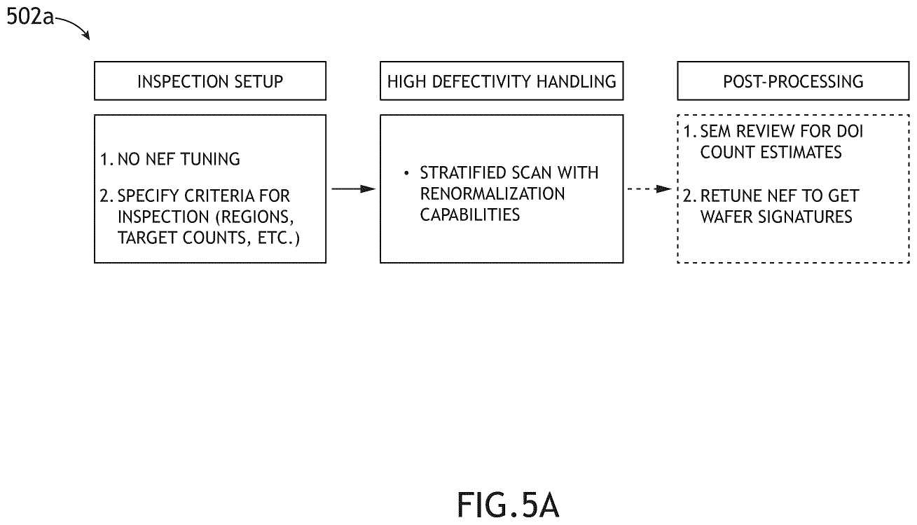

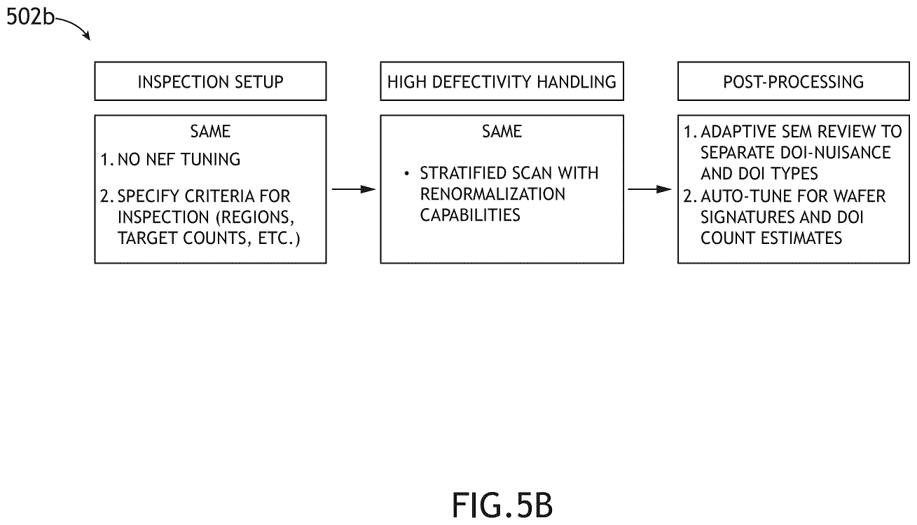

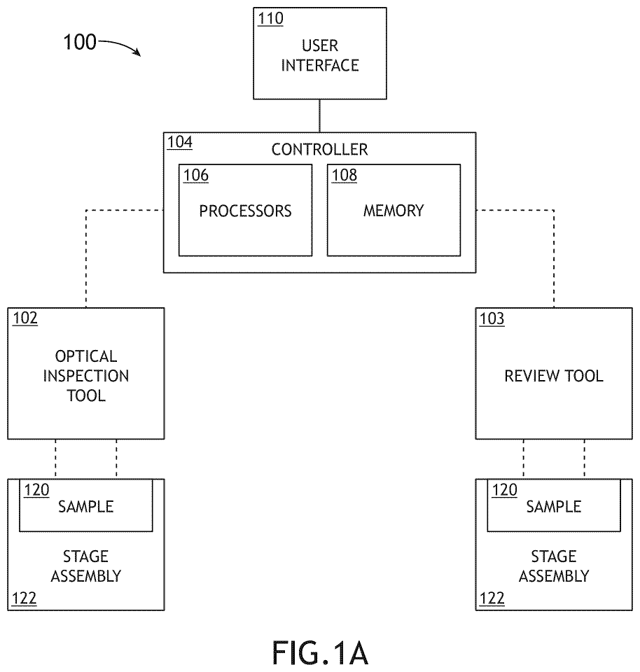

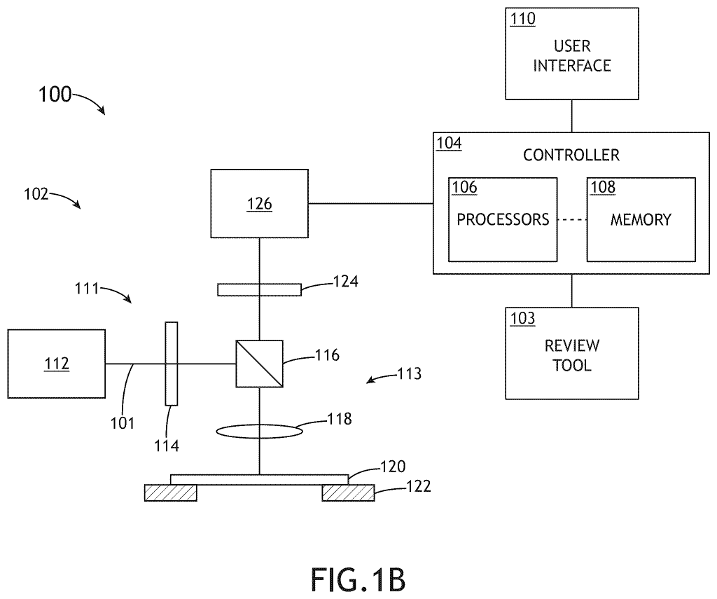

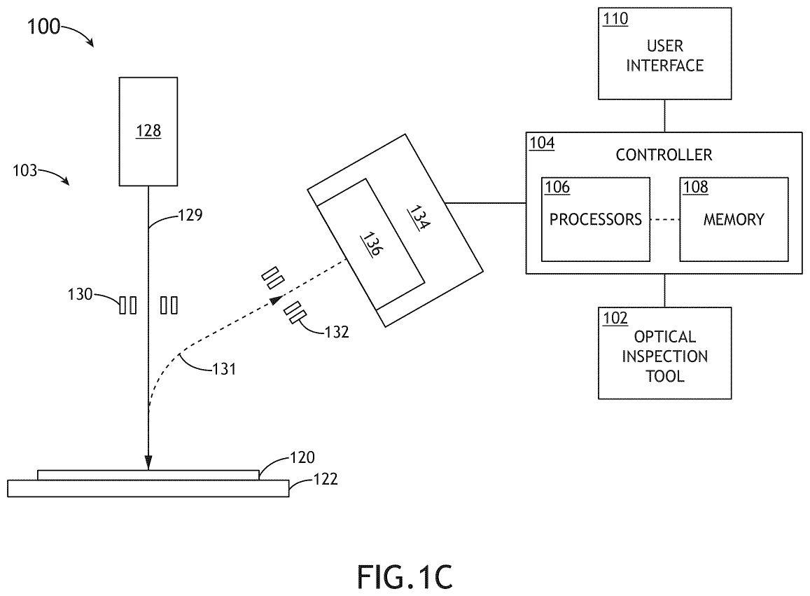

Referring now to FIGS. 1A-1C, a system 100 for dynamically inspecting a wafer is disclosed, in accordance with one or more embodiments of the present disclosure.

FIG. 1A illustrates block diagram of a system 100 for performing a dynamic inspection process, in accordance with one or more embodiments of the present disclosure. In embodiments, the system 100 includes an optical inspection tool 102. In embodiments, the system 100 includes a review tool 103. The system 100 may additionally include, but is not limited to, a controller 104 including one or more processors 106, a memory 108, and a user interface 110.

In embodiments, the one or more processors 106 may be communicatively coupled to memory 108, wherein the one or more processors 106 are configured to execute a set of program instructions stored on memory 108, the set of program instructions configured to cause the one or more processors 106 to carry out various functions and steps of the present disclosure. In this regard, the controller 104 may be configured to: receive an unsupervised optical scan of the wafer 120 from an optical inspection tool 102; generate contextual outliers for the wafer 120, wherein the contextual outliers are unique for the wafer 120; partition inspection results from the unsupervised optical scan of the wafer 120 into a plurality of strata based on a strength of signal for each event detected by the unsupervised optical scan; determine a fixed number of the events to be partitioned into each of the plurality of strata; review the unsupervised optical scan with an electron beam scan of the wafer received from a review tool 103; determine an estimated number of defects of interest based on results of the electron beam scan of the wafer 120; and determine one or more defect type classifications based on the electron beam scan of the wafer 120. Additionally, the set of program instructions may be further configured to cause the one or more processors 106 to: perform adaptive sampling during the electron beam scan of the wafer; display wafer signatures for each of the one or more defect type classifications; and separate defects of interest from nuisances. Each of these steps/functions of the controller 104 will each be described in further detail herein.

In embodiments, the controller 104 is communicatively coupled to the optical inspection tool 102 and the review tool 103. In this regard, the one or more processors 106 of the controller 104 may be configured to generate one or more control signals configured to adjust one or more characteristics of the optical inspection tool 102 and the review tool 103.

FIG. 1B illustrates a simplified schematic view of the system 100 for dynamic inspection of a wafer, in accordance with one or more embodiments of the present disclosure. In particular, FIG. 1B illustrates a system 100 including an optical inspection tool 102.

The optical inspection tool 102 may include any optical-based inspection/characterization system known in the art. The optical inspection tool 102 may include, but is not limited to, an illumination source 112, an illumination arm 111, a collection arm 113, and a detector assembly 126. The optical inspection tool 102 may be configured to perform an optical scan of a wafer 120.

In embodiments, optical inspection tool 102 is configured to inspect and/or measure the wafer 120 disposed on the stage assembly 122. Illumination source 112 may include any illumination source known in the art for generating illumination 101 including, but not limited to, a broadband plasma source. In embodiments, optical inspection tool 102 may include an illumination arm 111 configured to direct illumination 101 to the wafer 120.

Wafer 120 may include any wafer known in the art including, but not limited to, a wafer, a reticle, a photomask, and the like. For example, the wafer 120 may include a blank reticle. In embodiments, wafer 120 is disposed on a stage assembly 122 to facilitate movement of wafer 120. In embodiments, the stage assembly 122 is an actuatable stage. For example, the stage assembly 122 may include, but is not limited to, one or more translational stages suitable for selectively translating the wafer 120 along one or more linear directions (e.g., x-direction, y-direction, and/or z-direction). By way of another example, the stage assembly 122 may include, but is not limited to, one or more rotational stages suitable for selectively rotating the wafer 120 along a rotational direction. By way of another example, the stage assembly 122 may include, but is not limited to, a rotational stage and a translational stage suitable for selectively translating the wafer 120 along a linear direction and/or rotating the wafer 120 along a rotational direction. It is noted herein that the system 100 may operate in any scanning mode known in the art.

The illumination arm 111 may include any number and type of optical components known in the art. In embodiments, the illumination arm 111 includes one or more optical elements 114, a set of one or more optical elements 115, a beam splitter 116, and an objective lens 118. In this regard, illumination arm 111 may be configured to focus illumination 101 from the illumination source 112 onto the surface of the wafer 120. The one or more optical elements 114 may include any optical elements known in the art including, but not limited to, one or more mirrors, one or more lenses, one or more polarizers, one or more beam splitters, wave plates, and the like.

In embodiments, optical inspection tool 102 includes a collection arm 113 configured to collect illumination reflected or scattered from wafer 120. In embodiments, collection arm 113 may direct and/or focus the reflected and scattered light to one or more sensors of a detector assembly 126 via one or more optical elements 124. The one or more optical elements 124 may include any optical elements known in the art including, but not limited to, one or more mirrors, one or more lenses, one or more polarizers, one or more beam splitters, wave plates, and the like. It is noted that detector assembly 126 may include any sensor and detector assembly known in the art for detecting illumination reflected or scattered from the wafer 120.

In embodiments, the detector assembly 126 of the optical inspection tool 102 is configured to collect metrology data of the wafer 120 based on illumination reflected or scattered from the wafer 120. In embodiments, the detector assembly 126 is configured to transmit collected/acquired images and/or metrology data to the controller 104.

As noted previously herein, the controller 104 of system 100 may include one or more processors 106 and memory 108. The memory 108 may include program instructions configured to cause the one or more processors 106 to carry out various steps of the present disclosure. In embodiments, the program instructions are configured to cause the one or more processors 106 to adjust one or more characteristics of the optical inspection tool 102 in order to perform one or more measurements of the wafer 120.

FIG. 1C illustrates a system 100 for characterizing a wafer 120, in accordance with one or more embodiments of the present disclosure. In particular, FIG. 1C illustrates a system 100 including a review tool 103. In embodiments, the review tool 103 is configured as a scanning electron microscope (SEM) review tool.

In embodiments, the review tool 103 is configured to perform one or more measurements on the wafer 120. In this regard, the review tool 103 may be configured to acquire one or more images of the wafer 120. The review tool 103 may include, but is not limited to, electron beam source 128, one or more electron-optical elements 130, one or more electron-optical elements 132, and an electron detector assembly 134 including one or more electron sensors 136. For example, the review tool 103 may be configured to perform an electron beam scan of the wafer 120.

In embodiments, the electron beam source 128 is configured to direct one or more electron beams 129 to the wafer 120. The electron beam source 128 may form an electron-optical column. In embodiments, electron beam source 128 includes one or more additional and/or alternative electron-optical elements 130 configured to focus and/or direct the one or more electron beams 129 to the surface of the wafer 120. In embodiments, the review tool 103 includes one or more electron-optical elements 132 configured to collect secondary and/or backscattered electrons 131 emanated from the surface of the wafer 120 in response to the one or more electron beams 129. It is noted herein that the one or more electron-optical elements 130 and the one or more electron-optical elements 132 may include any electron-optical elements configured to direct, focus, and/or collect electrons including, but not limited to, one or more deflectors, one or more electron-optical lenses, one or more condenser lenses (e.g., magnetic condenser lenses), one or more objective lenses (e.g., magnetic condenser lenses), and the like.

It is noted that the electron optical assembly of the review tool 103 is not limited to the electron-optical elements depicted in FIG. 1C, which are provided merely for illustrative purposes. It is further noted that the system 100 may include any number and type of electron-optical elements necessary to direct/focus the one or more electron beams 129 onto the wafer 120 and, in response, collect and image the emanated secondary and/or backscattered electrons 131 onto the electron detector assembly 134.

For example, the system 100 may include one or more electron beam scanning elements (not shown). For instance, the one or more electron beam scanning elements may include, but are not limited to, one or more electromagnetic scanning coils or electrostatic deflectors suitable for controlling a position of the one or more electron beams 129 relative to the surface of the wafer 120.

In embodiments, secondary and/or backscattered electrons 131 are directed to one or more sensors 136 of the electron detector assembly 134. The electron detector assembly 134 of the review tool 103 may include any electron detector assembly known in the art suitable for detecting backscattered and/or secondary electrons 131 emanating from the surface of the wafer 120. Further, each electron-detecting portion of the detector array of the electron detector assembly 134 may be positioned so as to detect an electron signal from wafer 120 associated with one of the incident one or more electron beams 129. The electron detector assembly 134 may include any type of electron detector known in the art.

While FIG. 1C illustrates the review tool 103 as including an electron detector assembly 134 comprising only a secondary electron detector assembly, this is not to be regarded as a limitation of the present disclosure. In this regard, it is noted that the electron detector assembly 134 may include, but is not limited to, a secondary electron detector, a backscattered electron detector, and/or a primary electron detector (e.g., an in-column electron detector). In embodiments, review tool 103 may include a plurality of electron detector assemblies 134.

In embodiments, the one or more processors 106 of the controller 104 are configured to analyze the output of detector assembly 126/electron detector assembly 134. In embodiments, the set of program instructions are configured to cause the one or more processors 106 to analyze one or more characteristics of wafer 120 based on images received from the detector assembly 126/electron detector assembly 134. In embodiments, the set of program instructions are configured to cause the one or more processors 106 to modify one or more characteristics of system 100 in order to maintain focus on the wafer 120 and/or the detector assembly 126/electron detector assembly 134. For example, the one or more processors 106 may be configured to adjust one or more characteristics of the illumination source 112/electron beam source 128 and/or other elements of system 100 in order to focus the illumination 101 and/or one or more electron beams 129 onto the surface of the wafer 120. By way of another example, the one or more processors 106 may be configured to adjust the one or more elements of system 100 in order to collect illumination and/or secondary electrons 131 from the surface of the wafer 120 and focus the collected illumination on the detector assembly 126/electron detector assembly 134. By way of another example, the one or more processors 106 may be configured to adjust one or more focusing voltages applied to one or more electrostatic deflectors of electron beam source 128 in order to independently adjust the position or alignment of the one or more electron beams 129 and scan the electron beams 129 across the wafer 120.

The one or more processors 106 of a controller 104 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 106 may include any device configured to execute algorithms and/or instructions (e.g., program instructions stored in memory). In some embodiments, the one or more processors 106 may be embodied as a desktop computer, mainframe computer system, workstation, image computer, parallel processor, networked computer, or any other computer system configured to execute a program configured to operate or operate in conjunction with the system 100, as described throughout the present disclosure. Moreover, different subsystems of system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 104 may include one or more controllers housed in a common housing or within multiple housings. In this way, any controller or combination of controllers may be separately packaged as a module suitable for integration into the system 100.

The memory 108 may include any storage medium known in the art suitable for storing program instructions executable by the associated one or more processors 106. For example, the memory 108 may include a non-transitory memory medium. By way of another example, the memory 108 may include, but is not limited to, a read-only memory (ROM), a random-access memory (RAM), a magnetic or optical memory device (e.g., disk), a magnetic tape, a solid-state drive, and the like. It is further noted that the memory 108 may be housed in a common controller housing with the one or more processors 106. In some embodiments, the memory 108 may be located remotely with respect to the physical location of the one or more processors 106 and the controller 104. For instance, the one or more processors 106 of the controller 104 may access a remote memory (e.g., server), accessible through a network (e.g., internet, intranet, and the like).

In embodiments, as shown in FIGS. 1A-1C, system 100 includes a user interface 110 communicatively coupled to the controller 104. In embodiments, the user interface 110 includes a user input device and a display. The user input device of the user interface 110 may be configured to receive one or more input commands from a user, the one or more input commands configured to input data into system 100 and/or adjust one or more characteristics of system 100. In embodiments, the display of the user interface 110 may be configured to display data of system 100 to a user. The user interface 110 may include, but is not limited to, one or more desktops, laptops, tablets, and the like. In embodiments, the user interface 110 includes a display used to display data of the system 100 to a user. The display of the user interface 110 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 110 is suitable for implementation in the present disclosure. In embodiments, a user may input selections and/or instructions responsive to data displayed to the user via a user input device of the user interface 110.

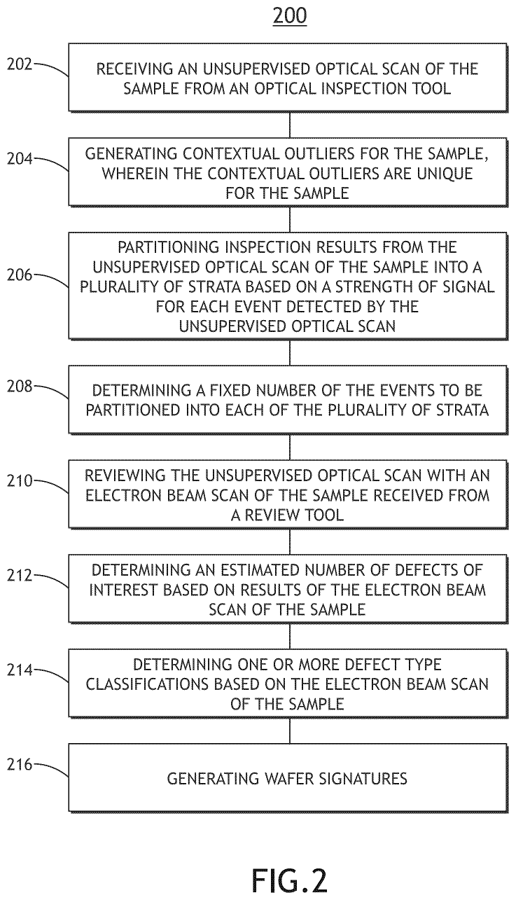

FIG. 2A illustrates a flow diagram depicting a method 200 of dynamic inspection of a wafer, in accordance with one or more embodiments of the present disclosure. Applicant notes that the embodiments and enabling technologies described previously herein in the context of the system 100 should be interpreted to extend to method 200. It is further noted, however, that the method 200 is not limited to the architecture of the system 100. For example, the method may be performed by the system 100 and one or more steps of method 200 may be executed by the controller 104 of the system 100.

It is contemplated that the method 200 as described herein may allow for inspection of wafers where inspection is different for each wafer. In this way, processes may be continuously adjusted and inspection will adapt to provide meaningful and actionable results.

In embodiments, the method 200 includes a step 202 of receiving an unsupervised optical scan of the wafer from an optical inspection tool. These unsupervised scans may be performed without any tuning (e.g., without nuisance event filtering (NEF) tuning) for wafers. However, criteria for inspection, such as regions of the wafer to be inspected or target counts for defects may be specified.

In embodiments, the method 200 includes a step 204 of generating contextual outliers for the wafer, wherein the contextual outliers are unique for the wafer. Generation of contextual outliers is described in U.S. Pat. No. 11,114,324, entitled “Defect Candidate Generation for Inspection” and issued on Sep. 7, 2021, which is incorporated herein by reference in its entirety. Generation of contextual outliers may involve executing a nuisance floor mapping algorithm to determine which events detected on a scan of a wafer are outliers and which other events are in line with the majority of detected events. Broadly, contextual outliers may be generated by detecting defect candidates on the wafer by applying one or more predetermined criteria to results of the optical scan to designate a portion of the detected outliers as the defect candidates.

Contextual outliers may be determined from segmented results. Outliers in the results may be found based on their signal strength (e.g., events having a stronger signal than others). Additionally, contextual outliers may be determined based on a number of contexts. For example, contexts may include, but are not limited to, design patterns or patterns in inspection images.

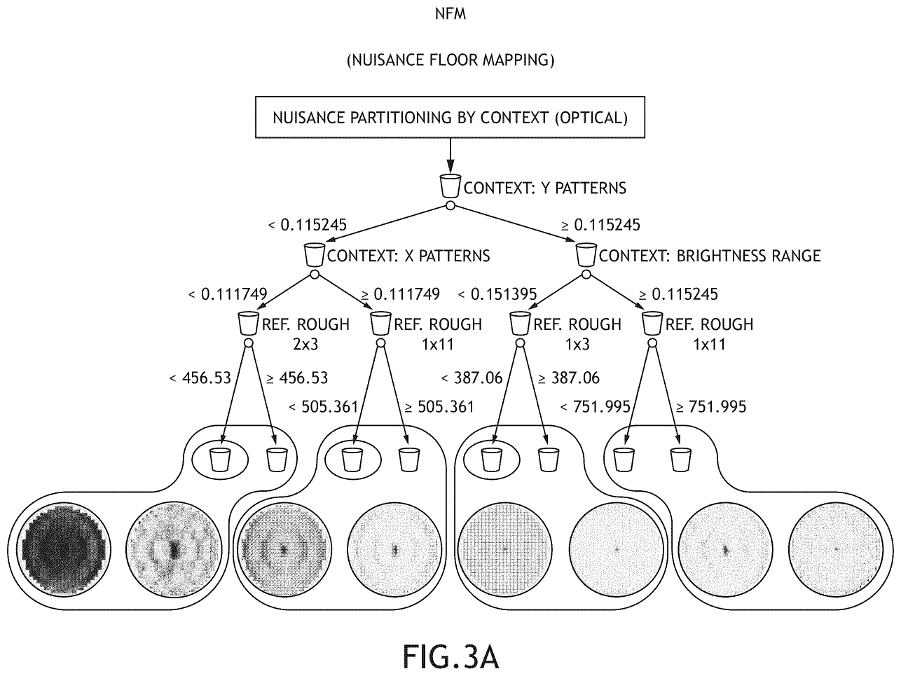

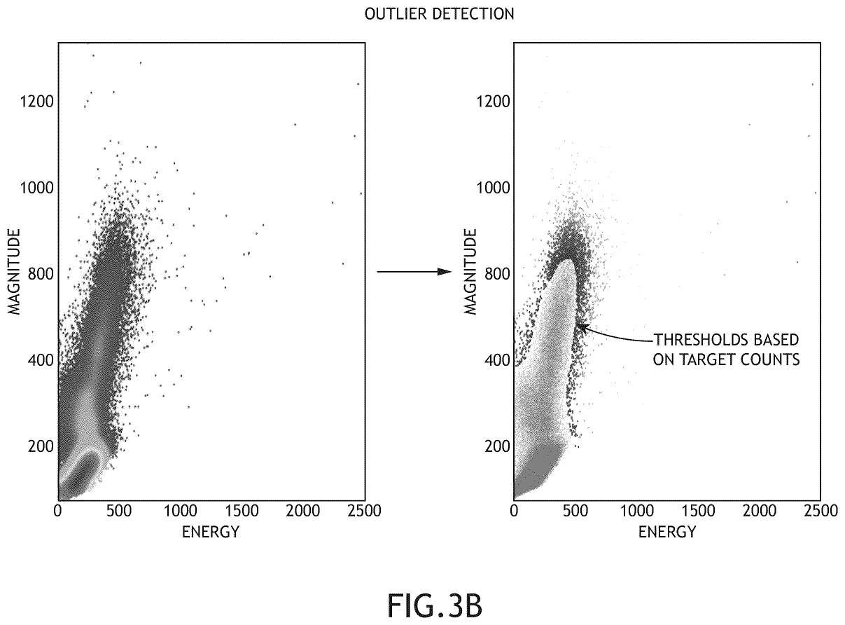

Referring now to FIGS. 3A and 3B, conceptual views of the process of the generation of contextual outliers 302 is illustrated. FIG. 3A illustrates determining contextual outliers 302, in accordance with one or more embodiments of the present disclosure. FIG. 3B illustrates a graph of events from an optical scan based on signal strength, in accordance with one or more embodiments of the present disclosure.

In FIG. 3A, the results of an optical scan of a wafer are shown. These results are broken into defect candidates through predetermined criteria, where a select number are considered to be defect candidates. These defect candidates may then be plotted on a graph, such as shown in FIG. 3B based on magnitude and energy.

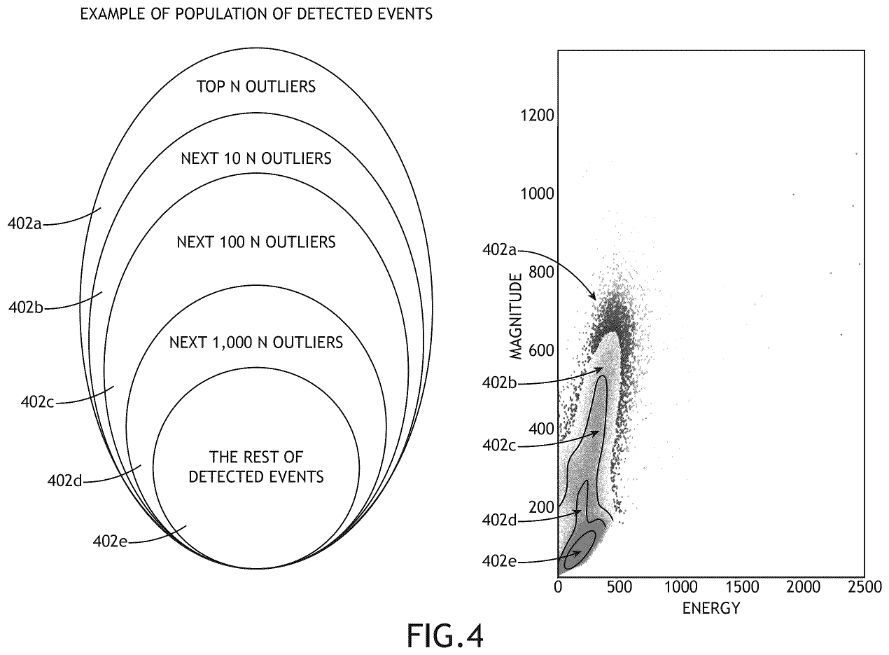

In embodiments, the method 200 includes a step 206 of partitioning inspection results from the unsupervised optical scan of the wafer into a plurality of strata based on a strength of signal for each event detected by the unsupervised optical scan. For example, FIG. 4 illustrates a conceptual view of a process of stratifying the events into different strata 402, in accordance with one or more embodiments of the present disclosure.

It is contemplated herein that partitioning the inspection results into the plurality of strata may be based on their signal strength as contextual outliers. Therefore, the strata may be independent of the defect classification (e.g., the type of defect). Additionally, partitioning the inspection results into the plurality of strata may be performed for each context for which contextual outliers are determined.

In FIG. 4, arrows indicate how the five strata 402a-e align with different events that were detected during the first optical scan of the wafer. As an illustration, FIG. 4. illustrates five strata 402a-e, which correspond to five regions on the graph. The five strata 402a-e illustrated in FIG. 4 should be interpreted as illustrative rather than limiting, as any number of strata 402 may be used to partition the events detected in the unsupervised optical scan. The top stratum 402a may correspond to events detected during the optical scan with the strongest signals (e.g., events with a high magnitude and/or energy). Each subsequent stratum 402b-e may then include events with signals weaker than the previous strata.

In embodiments, the method 200 includes a step 208 of determining a fixed number of the events to be partitioned into each of the plurality of strata. It should be noted that each stratum 402 may have a fixed number of events, however, different strata 402 may include different numbers of events. For example, strata (e.g., strata 402e) that include events with weaker signals may include more events than strata (e.g., strata 402a) that include events with stronger signals.

The top stratum 402a may include a fixed number of events, where the events in the top stratum 402a correspond to events having the strongest signals. The number of events partitioned into the subsequent strata 402b-e may be controlled by down sampling the events with a renormalizable sampling strategy. This may result in a reduction ratio being generated.

For example, in FIG. 4, the reduction ratio is 10, where each subsequent stratum 402 will include ten times more events than the previous stratum 402. Thus, as signals get progressively weaker, the number of events portioned into a stratum increases exponentially. As an illustration, the top stratum may include N events (e.g., the top N outliers or the N events with the strongest signal). The second stratum 402b may then include 10N events, which correspond to the next 10N outliers that were not accounted for in the top stratum 402a. The third stratum 402c may then include 100N events, which correspond to the next 100N outliers that were not accounted for in the top stratum 402a or the second stratum 402b. This pattern may continue until all events have been partitioned into a stratum 402. The bottom stratum 402e may include any residual events not included in any preceding stratum 402a-d.

It is noted that a reduction ratio of 10 should be interpreted as illustrative rather than limiting. The reduction ratio may be any number, including fractional numbers. It is contemplated that as sampling gets more aggressive, larger reduction ratios may be required to accommodate all detected events into a desired number of strata 402.

This strategy may permit any number of detected events to be accommodated regardless of how many events are detected on a wafer or the strength and nature of noise on the wafer. As such, the only aspects of inspection that may be affected is the reduction ratio, and as a result, sampling and defect count estimation errors. However, inspection blowups may be avoided, while maintaining the ability to track defect counts without bias may be maintained.

In embodiments, the method 200 includes a step 210 of reviewing the unsupervised optical scan with an electron beam scan of the wafer received from a review tool. Reviewing the unsupervised optical scan with a review tool may allow for enhanced defect detection on the wafer, as the review tool may have an enhanced resolution when compared to the optical inspection tool.

In embodiments, the method 200 includes a step 212 of determining an estimated number of defects of interest based on results of the electron beam scan of the wafer. For example, a small number of estimated defects may indicate that the fabrication process is working in a manner close to how it should work, while a large number of estimated defects may indicate that the fabrication process still requires a significant amount of refinement.

In embodiments, the method 200 includes a step 214 of determining one or more defect type classifications based on the electron beam scan of the wafer. The one or more defect type classifications may include, for example, an open, a bridge, a scratch, a residue, a particle, an under etch, or missing via. Each of these defect type classifications may correspond to a different issue during fabrication of the wafer.

In embodiments, the method 200 includes a step 216 of generating wafer signatures. A wafer signature (e.g., a spatial signature) may be a unique pattern or set of data obtained by analyzing the wafer. For example, the wafer signature may be a unique distribution of wafer defects originating from a single manufacturing problem. Therefore, a wafer signature may reveal patterns related to the manufacturing process and facilitate processing refinement.

To obtain wafer signatures of defects of interest, a secondary threshold may be used to create bins (e.g., groupings) for each defect of interest type with low impurity. The bin purity may important to properly visualize the wafer signature of the particular defect of interest.

In embodiments, the method 200 includes a step of performing adaptive sampling during the electron beam scan of the wafer. Adaptive sampling may allow for a fully automated inspection process. However, it should be noted that adaptive sampling need not be implemented for the method 200 to serve its function of defect detection on highly defective wafers. Instead, without adaptive sampling, manual intervention may be necessary in post-processing to refine inspection. Adaptive sampling may be broadly defined as adjusting the distribution of sampling points based on conditions of the wafer, such as, but not limited to, differences in wafer noise, film thickness (i.e., wafer reflectivity), and differences in defectivity.

In embodiments, the method 200 includes a step of displaying wafer signatures for each of the one or more defect type classifications. Wafer signatures may correspond to a distinct pattern of defects that in turn may indicate a particular issue with the fabrication process.

In embodiments, the method 200 includes a step of separating defects of interest from nuisances. For example, the optical scan may include many more nuisances than defects of interest. However, the nuisances may not affect performance of the fabricated component, while defects of interest may affect performance of the fabricated component. Thus, it may be critical for the purposes of inspection to differentiate between nuisances and defects of interest.

In embodiments, the method 200 includes a step of comparing two wafers with different process conditions using dynamic inspection. For example, the two wafer with different process conditions may be compared because we tune the dynamic inspection to the same operating point for wafer signatures. Additionally, tuning the dynamic inspection to the same operating point to produce the estimated number of defects of interest may allow the estimated number of defects to be reflective of the actual defect count differences between different wafers. Additionally, the estimated number of defects of interest generated with this technique may produce more accurate estimated number of defects of interest than static inspection.

The same operating point may mean that the thresholds are placed so that the same fraction of defects of interest is captured by inspections on different wafers. By doing so, the estimates may accurately track the relative defectivity on different wafers.

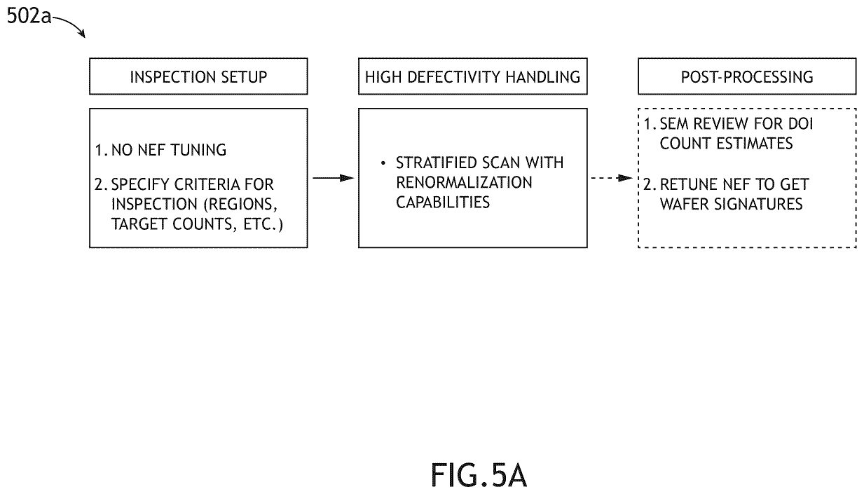

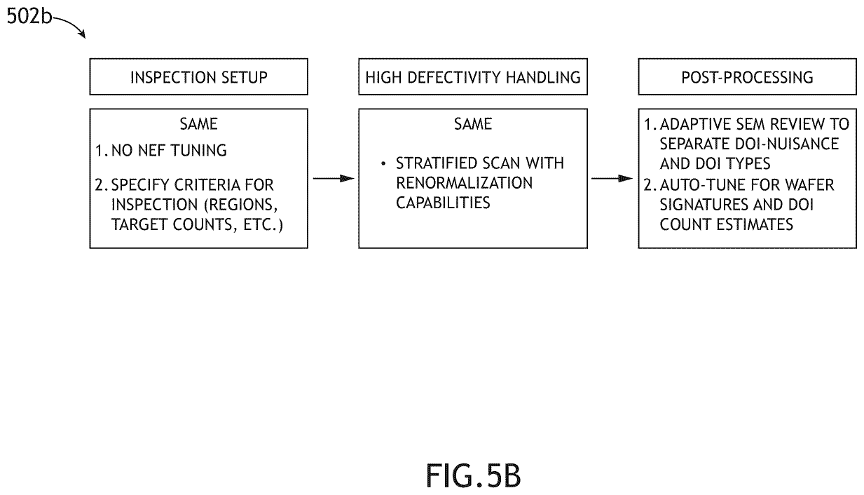

It is contemplated that the all, or part, of the steps of the method 200 may be embodied as two separate inspection flows 502. FIG. 5A illustrates first inspection flow 502a, in accordance with one or more embodiments of the present disclosure. FIG. 5B illustrates a second inspection flow 502b, in accordance with one or more embodiments of the present disclosure.

The main difference between the first inspection flow 502a and the second inspection flow may be in the post-processing component of inspection. In this way, the first inspection flow 502a may require manual intervention during post-processing, while the second inspection flow 502b may require no manual intervention during post-processing. For example, the first inspection flow 502a may require manual tuning of the scans (e.g., of the nuisance event filtering) after fully unsupervised inspection and review by the review tool in order to determine wafer signatures for various defect types. By way of another example, the second inspection flow 502b may include adaptive sampling during review by the review tool. This may allow for fully automated inspection and tuning. Additionally, this may allow for optimal partitioning results and automated display of wafer signatures for each defect type. It is contemplated that the full automation of the second inspection flow 502b may include the existence of an SEM classifier.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed is:

1. A system for dynamic inspection of a wafer comprising:
a controller including one or more processors configured to execute a set of program instructions stored in memory, the set of program instructions configured to cause the one or more processors to:
receive an unsupervised optical scan of the wafer from an optical inspection tool;
generate contextual outliers for the wafer, wherein the contextual outliers are unique for the wafer;
partition inspection results from the unsupervised optical scan of the wafer into a plurality of strata based on a strength of signal for each event detected by the unsupervised optical scan;
determine a fixed number of the events to be partitioned into each of the plurality of strata;
review the unsupervised optical scan with an electron beam scan of the wafer received from a review tool;
determine an estimated number of defects of interest based on results of the electron beam scan of the wafer;
determine one or more defect type classifications based on the electron beam scan of the wafer; and
generate wafer signatures.

2. The system of claim 1, wherein the one or more defect type classifications comprise at least one of an open, a bridge, a scratch, a residue, a particle, an under etch, or missing via.

3. The system of claim 1, wherein a top stratum of the plurality of strata corresponds to the events with strongest signals.

4. The system of claim 3, wherein subsequent strata of the plurality of strata correspond to the events with weaker signals.

5. The system of claim 1, wherein the fixed number of the events to be partitioned into each of the plurality of strata is determined by down sampling the events.

6. The system of claim 5, wherein down sampling the events is performed with a renormalizable sampling strategy.

7. The system of claim 1, wherein the fixed number of the events to be partitioned into each of the plurality of strata is determined with a reduction ratio.

8. The system of claim 1, wherein the electron beam scan of the wafer is unsupervised.

9. The system of claim 1, wherein determining one or more defect type classifications based on the electron beam scan of the wafer includes manual tuning of the electron beam scan.

10. The system of claim 1, wherein the set of program instructions are further configured to cause the one or more processors to:
perform adaptive sampling during the electron beam scan of the wafer.

11. The system of claim 1, wherein the set of program instructions are further configured to cause the one or more processors to:
display wafer signatures for each of the one or more defect type classifications.

12. The system of claim 1, wherein the set of program instructions are further configured to cause the one or more processors to:
separate defects of interest from nuisances.

13. The system of claim 1, wherein the one or more processors are provided with inspection criteria.

14. The system of claim 13, wherein the inspection criteria includes one or more of inspection regions or target defects.

15. The system of claim 1, wherein the set of program instructions are further configured to cause the one or more processors to:
compare two wafers with different process conditions using dynamic inspection.

16. The system of claim 15, wherein the dynamic inspection is tuned to the same operating point to produce the estimated number of defects of interest to be reflective of the actual defect count differences between different wafers.

17. The system of claim 1, wherein the wafer signatures of the defects of interest are generated by creating bins based on a secondary threshold for each defect of interest type with low impurity.

18. A system for dynamic inspection of a wafer, comprising:
an optical inspection tool;
a review tool; and
a controller communicatively coupled to the optical inspection tool and the review tool, the controller including one or more processors configured to execute a set of program instructions stored in memory, the set of program instructions configured to cause the one or more processors to:
receive an unsupervised optical scan of the wafer from the optical inspection tool;
generate contextual outliers for the wafer, wherein the contextual outliers are unique for the wafer;
partition inspection results from the unsupervised optical scan of the wafer into a plurality of strata based on a strength of signal for each event detected by the unsupervised optical scan;
determine a fixed number of the events to be partitioned into each of the plurality of strata;
review the unsupervised optical scan with an electron beam scan of the wafer received from the review tool;
determine an estimated number of defects of interest based on results of the electron beam scan of the wafer;
determine one or more defect type classifications based on the electron beam scan of the wafer; and
generate wafer signatures.

19. The system of claim 18, wherein the set of program instructions are further configured to cause the one or more processors to:
perform adaptive sampling during the electron beam scan of the wafer.

20. The system of claim 18, wherein the set of program instructions are further configured to cause the one or more processors to:
display wafer signatures for each of the one or more defect type classifications.

21. The system of claim 18, wherein the set of program instructions are further configured to cause the one or more processors to:
separate defects of interest from nuisances.

22. The system of claim 18, wherein the set of program instructions are further configured to cause the one or more processors to:
compare two wafers with different process conditions using dynamic inspection.

23. The system of claim 22, wherein the dynamic inspection is tuned to the same operating point to produce the estimated number of defects of interest to be reflective of the actual defect count differences between different wafers.

24. The system of claim 18, wherein the wafer signatures of the defects of interest are generated by creating bins based on a secondary threshold for each defect of interest type with low impurity.

25. A method for dynamic inspection of a wafer, comprising:
receiving an unsupervised optical scan of the wafer from an optical inspection tool;
generating contextual outliers for the wafer, wherein the contextual outliers are unique for the wafer;
partitioning inspection results from the unsupervised optical scan of the wafer into a plurality of strata based on a strength of signal for each event detected by the unsupervised optical scan;
determining a fixed number of the events to be partitioned into each of the plurality of strata;
reviewing the unsupervised optical scan with an electron beam scan of the wafer received from a review tool;
determining an estimated number of defects of interest based on results of the electron beam scan of the wafer; and
determining one or more defect type classifications based on the electron beam scan of the wafer; and
generating wafer signatures.

26. The method of claim 25, wherein the method further comprises:
performing adaptive sampling during the electron beam scan of the wafer.

27. The method of claim 25, wherein the method further comprises:
displaying wafer signatures for each of the one or more defect type classifications.

28. The method of claim 25, wherein the method further comprises:
separating defects of interest from nuisances.

29. The method of claim 25, wherein the method further comprises:
comparing two wafers with different process conditions using dynamic inspection.

30. The method of claim 29, wherein the dynamic inspection is tuned to the same operating point to produce the estimated number of defects of interest to be reflective of the actual defect count differences between different wafers.

31. The method of claim 25, wherein the wafer signatures of the defects of interest are generated by creating bins based on a secondary threshold for each defect of interest type with low impurity.
